(19) United States
(12) Patent Application Publication
(10) Pub. No.: US 2004/0115025 A1
(43) Pub. Date: Jun. 17, 2004

(54) Method for the application of a function element to a mouldable metal piece using a high pressure moulding process, assembled piece and die

(76) Inventor: Richard Humpert, Rosbach v. d. h. (DE)

Correspondence Address: GREENBERG TRAURIG, LLP, 885 3RD AVENUE, NEW YORK, NY, 10022, US

(21) Appl. No.: 10/470,516

(22) PCT Filed: Nov. 29, 2001
(86) PCT No.: PCT/EP01/13979

(30) Foreign Application Priority Data
Feb. 1, 2001 (DE) 101 04 549.2

(51) Int. Cl. F16B 37/04

(52) U.S. Cl. 411/180

(57) ABSTRACT

A method for the application of a function element (10, 101) to a mouldable metal piece (12) using a high pressure moulding process, whereby the metal piece (12) is put under load by means of a fluid pressure on the side away from the supported function element (10, 101) and moulded in a moulding process around at least one section of the function element in the region of a radially inward running surface of the function element, facing away from the front face (18) of the function element (10, 101) in contact with the metal piece, to give an annular rabbet running radially inwards with an annular form, the function element being supported throughout said process. Said method is characterised in that during a second phase of the moulding process the annular rabbet is pressed flat between a moulding surface of a die and the surface of the function element running radially inwards. The invention further relates to an assembled component produced by means of said method and a die used to carry out said method.

The present invention relates to a method for the attachment of a functional element to a deformable metal part using a high pressure forming process in which the metal part is exposed to a fluid pressure at the side remote from the supported functional element and is formed in a forming process starting from one end face of the functional element around at least one section of the functional element and, in the region of a radially inwardly extending surface of the functional element which is remote from the end face of the functional element contacting the metal part, into a ring-like radially inwardly directed ring-fold, with the functional element being supported during this forming process and also to a component assembly manufactured by this method and a die for using and carrying out the method.

A method of the initially named kind is known from DE-OS 19508632 A1. There a functional element in the form of a nut element is attached to a shaped sheet metal part by means of an internal high pressure forming process. The nut element is supported during the forming process on a movable spigot and this spigot has a projection provided at the thread which is screwed into the nut element prior to carrying out the forming process. By applying the forming pressure onto the side of the metal part remote from the spigot the metal is formed against the end face of the nut element and around its rounded outer contour and formed into a ring-fold which penetrates into a ring-shaped undercut which is located between the nut element and the spigot. By a retraction movement of the spigot, and thus also of the nut, regions of the undercut which are not yet fully filled with material of the shaped sheet metal part are pressed. The spigot is subsequently removed from the nut element by a superimposed rotation and thus retraction movement of the plunger, so that after opening of the tool the components (shaped sheet metal part and nut element), which have been connected in form-locked manner into a component assembly, can be jointly removed from the tool.

A form-fitted connection which is secure against loading with torques can be achieved by a multi-edged shape at the nut.

In one embodiment the threaded spigot of the spigot has a lower height relative to the nut and the nut furthermore has a recess at its side confronting the shaped sheet metal part, whereby a slug is pierced out of the shaped sheet metal part under the action of the forming pressure so that a screw which is later introduced into the nut element can also project beyond the end face of the nut element.

The object of the present invention is to improve a method of the initially named kind so that it is easier to carry out and so that a significantly firmer attachment of the functional element to the metal part takes place and an improved security against rotation can be achieved.

In order to satisfy this object provision is made method-wise that, in a second phase of the forming process, the ring-fold is pressed flat between a forming surface of a die and the radially inwardly extending surface of the functional element.

Since, in the known embodiment, a die is not present and the bore which receives the movable spigot has a diameter which is larger than the maximum diameter of the functional element, in order to be able to supply the element which is screwed onto the spigot through the bore of the tool to the shaped sheet metal part, the radially inwardly extending surface of the functional element does not lie directly opposite the tool so that, on retraction of the spigot, an actual pressing flat of the shaped sheet metal part can also not take place. In other respects the screwing in and screwing out of the spigot into and out of the respective functional element represents a complication which also leads to a considerable loss of time, which represents a decisive disadvantage for large production series.

Through the construction in accordance with the invention the ring-fold is however pressed flat between a forming surface of a die and the radially inwardly extending surface of the functional element opposite to the die, whereby the pressed flat ring fold is brought into quite intimate contact with the radially inwardly extending surface of the functional element, whereby a particularly secure attachment of the functional element is achieved. Since the metal part is pressed flat in the region of the ring fold a rigid connection is also present during the later attachment of a further component by means of a threaded element (bolt or nut), which is not ensured in the prior art.

Although this construction signifies that the functional element cannot be straightforwardly fed through a bore of the die which guides the plunger, the die which is located in a bore of the tool can be jointly retracted with the plunger in order to enable the introduction of a nut element into the working range of the plunger.

Moreover, it is not necessary in accordance with the invention to screw the plunger into a nut element, but rather it is completely sufficient, when using a hollow functional element, if the plunger has a cylindrical spigot which projects at least partly into the hollow functional element.

It is particularly favourable in the present invention when the radially inwardly extending surface of the functional element merges into a cylinder portion directed in the axial direction of the functional element and when, during the pressing flat of the ring fold, the cylinder portion is formed radially outwardly by shape features of the die so that at least a part of the ring fold lies between the radially inwardly extending surface of the functional element and the cylinder portion which has been changed in shape and is held firm there.

In this way not only is an even firmer attachment of the functional element to the metal part provided but rather it is also ensured that features of shape, which form a security against rotation between the functional element and the metal part and which are located in the region of the radially inwardly extending surface of the functional element and/or in the region of the cylinder portion, come fully into action during the forming of the metal part for the formation of the flat pressed ring fold and ensure an intimate inter-engagement of the metal part and the features of shape providing security against rotation, whereby the security against rotation of the connection between the functional element and the metal part is significantly improved.

Various possibilities exist for carrying out the second phase of the pressing flat of the ring fold.

In accordance with a first embodiment the support of the functional element by a plunger provided in the die is effected such that after the first phase of the forming process a rearward deflection of the plunger is permitted, whereby the second phase of the forming process can take place between the die surrounding the plunger and the metal part which is exposed to fluid pressure.

The plunger can for example be supported by a spring force and the rearward deflection of the plunger can be achieved by reduction of the spring force. Alternatively to this the plunger can be supported by a spring force and the rearward deflection of the plunger can be brought about by increase of the fluid pressure. In other words the spring force is overcome here by increasing the fluid pressure and thus the plunger is pressed rearwardly against the spring force. For such processes one needs a relatively strong spring. Such springs are however well known in mechanical engineering and used for other purposes in press tools in the form hydraulic springs and springs loaded with gas pressure. Alternatively, or in addition to the pressure dependent movement of the plunger, the support of the functional element can be carried out in accordance with the second embodiment of the invention by the die, with the second phase of the forming process simply taking place by an increase of the fluid pressure acting on the metal part. This variant can in particular be realised when the functional element has a cylinder portion. This cylinder portion can first be supported on the end face of the die, whereby a pronounced spacing is present between the radially inwardly extending surface of the functional element and the end face of the die and is determined by the length of the cylinder portion. In this way the ring fold can easily form in the so formed undercut. With increasing pressure the cylinder portion of the functional element begins to slide outwardly at the deflection surface of the die so that the said distance is reduced and the ring-fold which is present there is increasingly pressed flat.

In order to realize this variant it is in principle possible to fixedly arrange the die, it is however probably more favourable, in order to be able to introduce the functional elements into the region of the forming surface of the die, to design the die so that it is retracted in the open state of the tool in order to enable the introduction of the respective nut element.

A further possibility of realizing the pressing flat of the ring fold in accordance with the invention consists in biasing the die by a force in the direction of the metal part and by increasing the bias force acting on the forming surface of the die and the fluid pressure acting on the metal part in order to carry out the second phase of the forming process.

Furthermore, the possibility exists in all three aspects for carrying out the forming process, instead of increasing the pressure prevailing the pressure fluid, to operate with a tool which presses onto the metal part contacting the end face and hereby generates a mechanically increased forming force in order to achieve the pressing flat of the ring fold between the radially inwardly extending surface of the functional element and the die.

The functional element can either be a bolt element having a head part and a shaft part or, in the manner known per se, a nut element. Particularly preferred embodiments of the method can be found in the subordinate claims. Particularly preferred variants of the component assembly of the invention and also of the die are to be found in the further claims 22 to 32.

The present invention will now be described in more detail in the following with reference to embodiments and to the drawings which show:

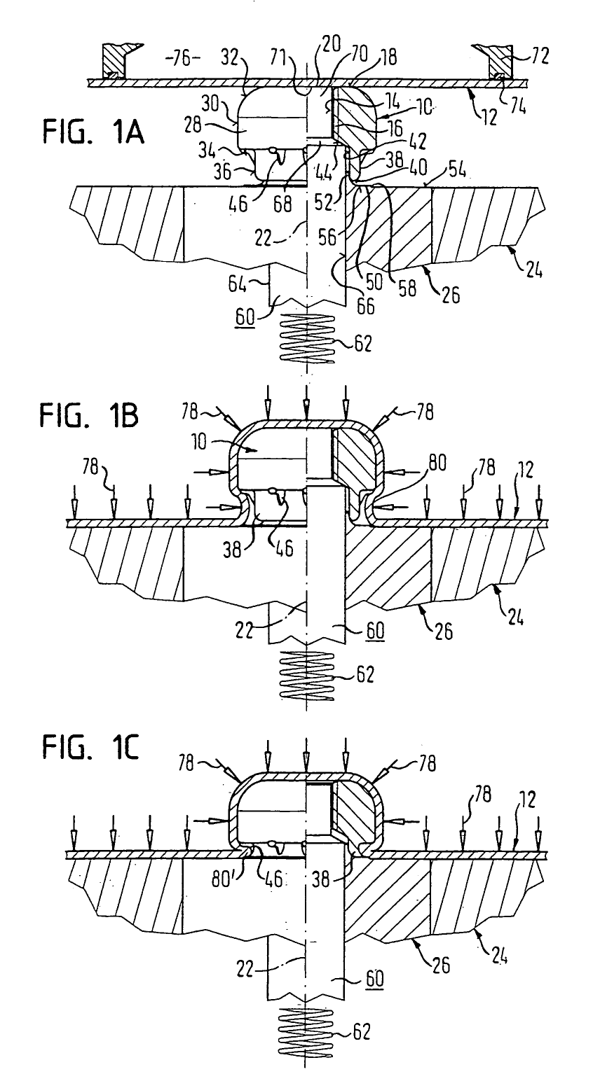

FIGS. 1A to 1C a series of drawings in order to represent the attachment, in accordance with the invention, of a hollow functional element to a metal part by means of a high pressure forming process,

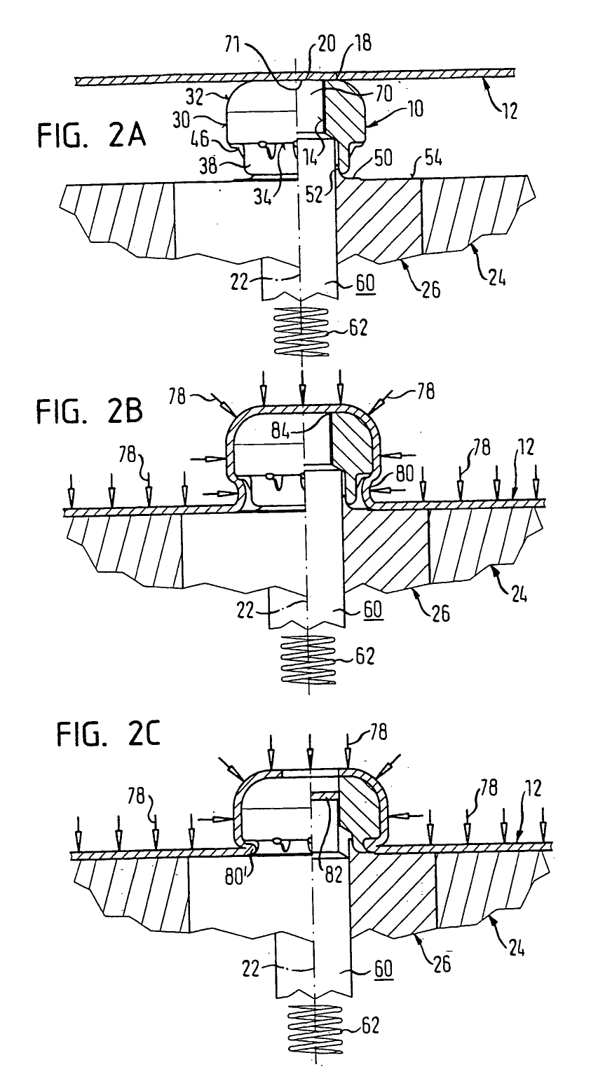

FIGS. 2A to 2C a sequence of drawings similar to the drawings of FIGS. 1A to 1C to explain the attachment of a hollow element to a metal part, with a slug being cut out from the metal part,

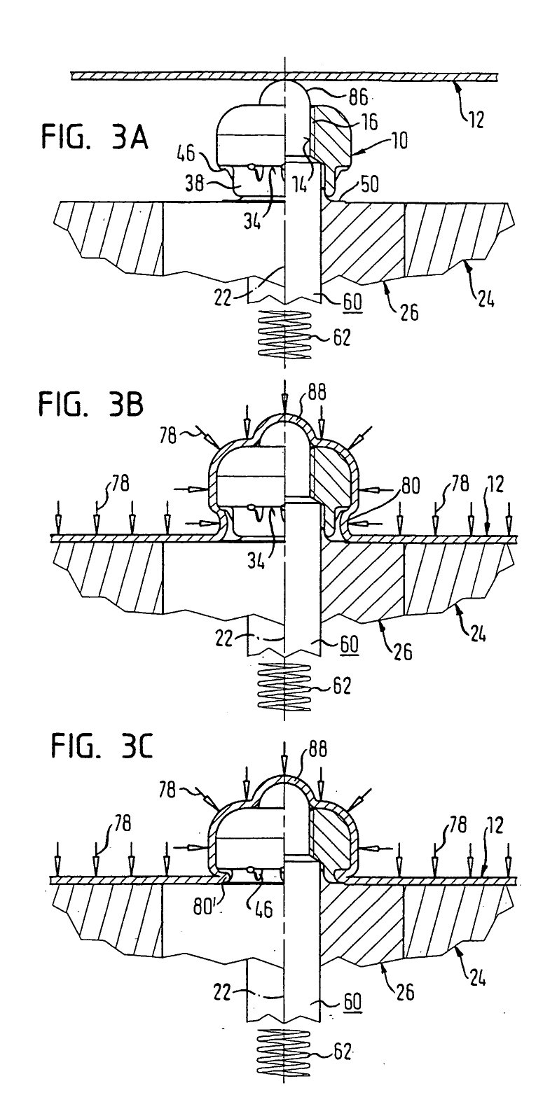

FIGS. 3A to 3C a further series of drawings similar to the drawings of FIGS. 1A to 1C in which however the plunger used has a special shape,

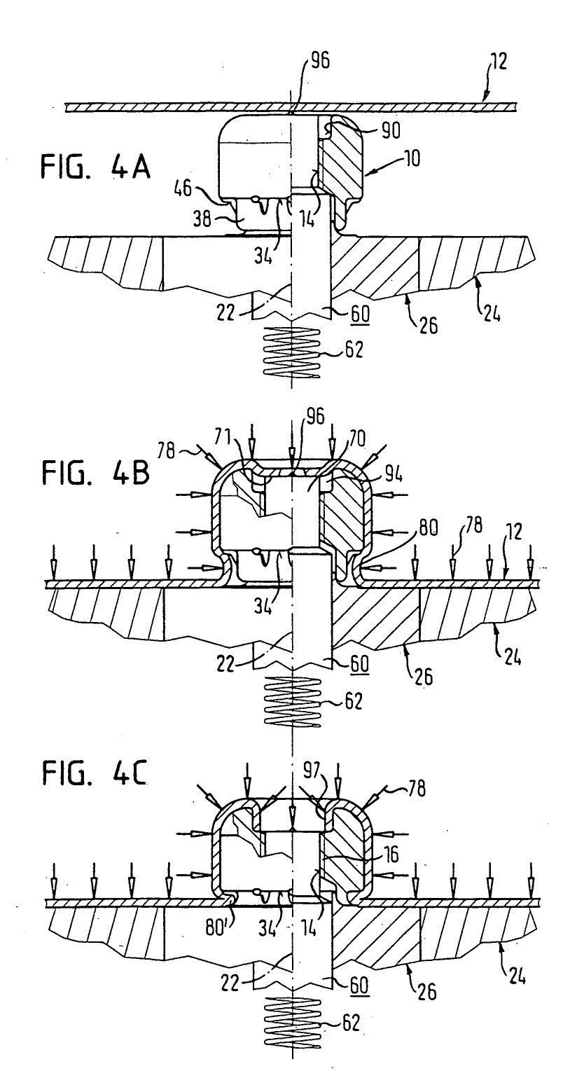

FIGS. 4A to 4C an additional series of drawings similar to the drawings of FIGS. 1A to 1C but with the metal part being pierced and changed in shape in the region of the one end face of the hollow functional element,

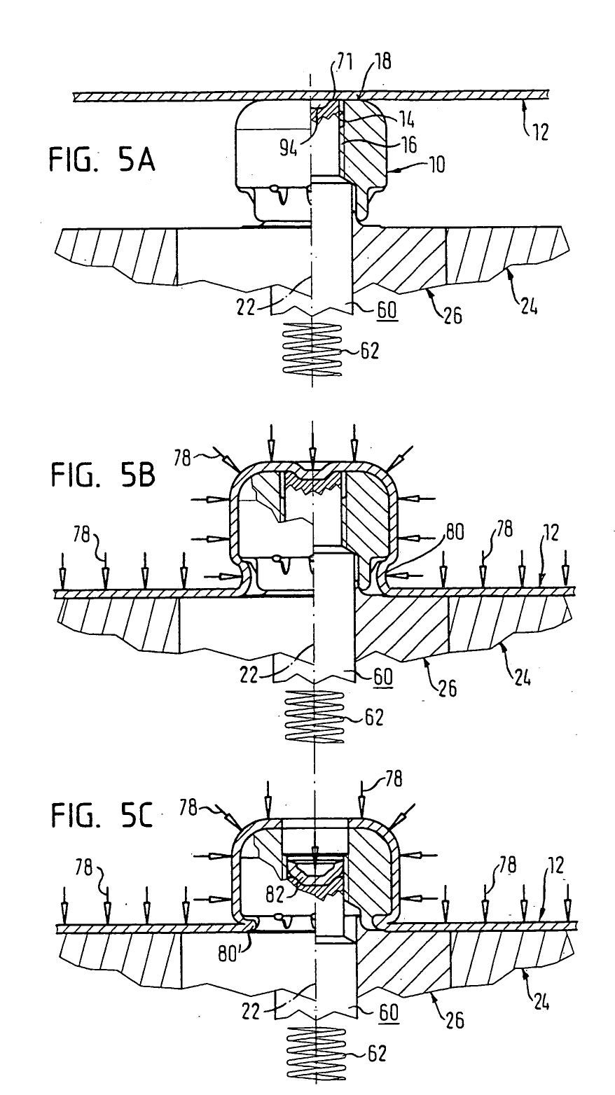

FIGS. 5A to 5C a further sequence of drawings similar to the drawings of the FIGS. 2A to 2C in order to represent a further variant, and

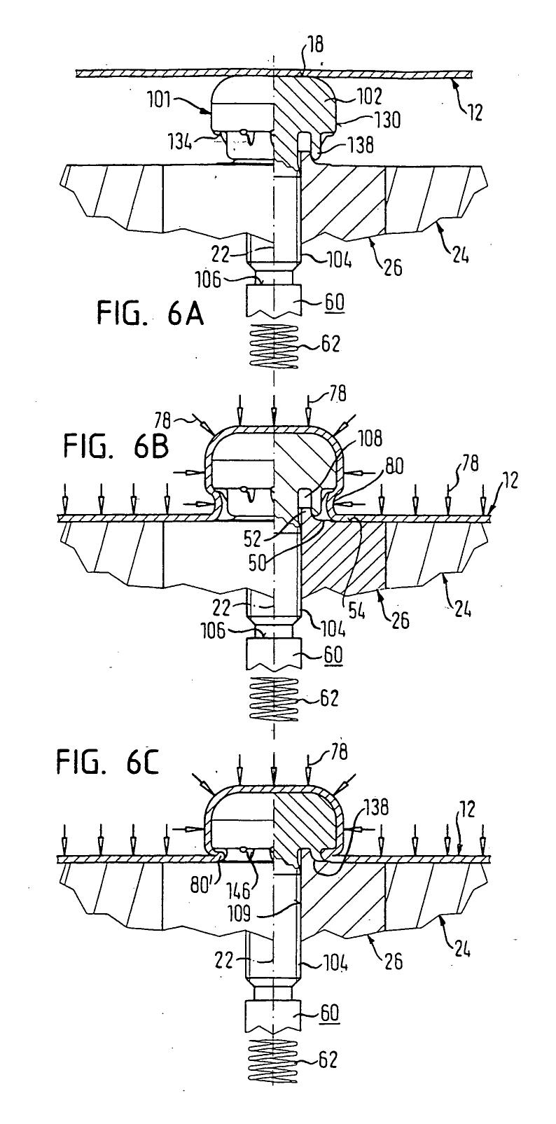

FIGS. 6A to 6C a series of drawings similar to the drawings of FIGS. 1A to 1C, but in modified form, for the representation of the attachment, in accordance with the invention, of a functional element in the form of a bolt element to a metal part.

FIGS. 1A to 1C show various phases during the attachment of a functional element in the form of a hollow nut element 10 to a metal part in the form of a shaped sheet metal part 12. The hollow functional element 10 has in this example a bore 14 which is provided with a thread cylinder 16 which opens at an end face of the functional element 10 confronting the shaped sheet metal part 12 into an at least substantially circular opening 20. The bore 14 provided with the thread cylinder 16 extends concentrically to the longitudinal direction 22 of the functional element which is simultaneously the longitudinal axis of a tool generally characterized by the reference numeral 24 with a die 26. The functional element 10 has a body section 28 with a jacket surface 30 and the end face 18 of the functional element 10 merges via a rounded shoulder 32 of the functional element into the jacket surface 30. This merges in turn into a radially inwardly extending surface 34, which in this example subsequently merges into the outer surface 36 of a cylinder portion 38. The free end 40 of the cylinder portion 38 remote from the end face 18 is rounded off and merges into a hollow region 42 in the interior of the cylinder portion 38 and this region 42 leads via an obliquely positioned shoulder surface 44, which later serves as an introduction aid for a screw, into the bore provided with the thread 16.

In the region of the transition between the radially inwardly extending surface 34 and the outer surface 36 of the cylinder portion 38 there are noses 46 providing security against rotation which are eight in number in this embodiment and which extend in raised form along the radially inwardly extending surface 34 and along the cylinder surface 36 of the cylinder portion 38. The number of features providing security against rotation and their shape can clearly be realized differently. They can for example only be provided on the radially extending surface 34 or only on the cylinder portion 38 and they can be realized not only as noses but also as recesses.

The element illustrated has a pronounced resemblance to the RSN element offered by the company Profil Verbindungstechnik GmbH & Co. KG.

As already indicated the functional element 10 is arranged above a die 26 with a ring-shaped forming surface 50 which is arranged concentric to the longitudinal axis 22. The forming surface 50 is arranged between an axial projection 52 and a ring surface 54 arranged flush with the upper side of the tool 24 and has a gently rounded transition from the projection 52 into the ring surface 56 which stands perpendicular to the longitudinal axis 22 and which merges via a small ring shoulder 58 into the ring face 54 at the end of the die 26, with the ring face 54 likewise being arranged perpendicular to the longitudinal axis 22.

Within the die there is located a plunger 60 which is biased upwardly via a schematically illustrated spring 62. The spring 62 is preferably a hydraulically biased spring which can exert a strong spring force. The plunger 60 has a cylindrical region 64 which is guided in the central longitudinal bore 66 of the die 26 and this merges via an obliquely set ring shoulder 68, whose inclination corresponds to that of the ring face 44, into a cylindrical spigot or projection 70 which is arranged within the threaded bore 14 and has an outer diameter which is fractionally smaller than the inner diameter of the threaded bore 14. The end face 71 of the spigot lies in this example flush with the end face 18 of the functional element 10.

Above the shaped sheet metal part 12 there is located in this embodiment a hold-down member 72 which, biased from above, is pressed against the shaped sheet metal part 12 and can be sealed relative to the latter via a seal 74. The hold-down member 72 defines a hollow cavity 76 which is filled with a pressure fluid, such as for example a pressure liquid.

First of all the hold-down member is pressed downwardly and the pressure in the space 76 is increased so that the shaped sheet metal part 12 is formed around the functional element 10 under the applied pressure and adopts the shape of FIG. 1B in a first phase of the forming process. From FIG. 1B one can see that the shaped sheet metal part has been pressed by the applied fluid pressure—schematically indicated by the arrows 78—against the end face 18 of the functional element 10, has been laid around the rounded ring shoulder 32 and the jacket surface 30 and has been formed, in the region between the radially inwardly extending surface 34 of the functional element 10 and the end face of the die 26, into a radially inwardly directed ring fold 80 which extends into the undercut formed between the surface 34 and the end face of the die.

During the first phase of the forming process the plunger 60 prevents the functional element 10 moving in the axial direction of the longitudinal axis 22, i.e. in this example the nut element 10 is supported by the plunger 60 at the ring face 44. Instead of this the functional element 10 can be supported by the cylindrical portion 38 at the forming surface 50 of the die 26. As a further alternative the functional element can be supported both by the plunger 60 and also-by the die 26.

The pressure of the hydraulically biased spring 62 is now either reduced or the fluid pressure (arrow 78) is increased, or both measures are carried out simultaneously so that the total force acting on the functional element 10 in the axial direction is sufficient, on the one hand, to press the ring fold 80 flat (to the shape, which is shown at 80′ in FIG. 1C) and simultaneously to shape the cylindrical portion 38 in the radial direction so that this adopts the position and shape of FIG. 1C. This deformation of the cylinder portion 38 is carried out by the rounded forming surface 50 of the die under the action of the prevailing axial forces.

One can see from FIG. 1C that the noses 46 providing security against rotation have been pressed into the sheet metal material of the ring fold. This can be quite clearly seen for the nose 46 providing security against rotation at the left side of FIG. 1C. Thus in this region a pronounced security against rotation is achieved which can also not become loose since the free end of the cylinder portion 38 which is been turned over in the radial direction fixedly clamps the material of the metal part in this region.

The tool can now be opened and the component assembly consisting of the shape metal part and of the functional element can either be lifted from, the spigot of plunger or the latter can be withdrawn downwardly in order to release the component assembly. It is particularly favourable when the die 26 with the plunger 60 is drawn away downwardly since one can then introduce a new functional element 10 via a corresponding feed channel (not shown) into the area of the plunger.

As an alternative to the increase in pressure or to the reduction of the spring force which leads to the second phase of the forming process, i.e. to the change in state from the state of FIG. 1B into the state of FIG. 1C, it would also be conceivable to exert an increased mechanical force on the end face of the functional element; this can take place in that a part of the tool 72 is pressed against the upper side of the metal part shown in FIG. 1C and presses the functional element 10 downwardly via the metal part.

In order to remove the component assembly from the tool in accordance with FIG. 1C spigots in the tool 24 can be actuated in a manner known per se in order to lift the component assembly upwardly into a released position above the end face 72 of the plunger 60 so that it can be removed out of the region of the tool. The tool can subsequently be equipped with a new shaped sheet metal part 12. The shaped sheet metal part 12 can also be a hollow structure, for example in the form of a tube, with the fluid pressure being built up in the hollow interior of the tube. With a construction of this kind it is necessary to provide an upper tool which stably supports the tube at its upper side and presses downwardly so that the forming process can be carried out.

The FIGS. 2A to 2C now show an embodiment which is slightly modified relative to the embodiment of FIGS. 1A to 1C and in these Figures, as also in all subsequent Figures, the same reference numerals are used as are also used in FIGS. 1A to 1C. It will be understood that parts, that are identified with the same reference numerals have the same design and the same function as the already described parts in the FIGS. 1A to 1C, so that a renewed description of these parts or their functions can be dispensed with. Instead of this only the important differences will be described for the embodiment of FIGS. 2A to 2C and in the further embodiments of FIGS. 3A to 3C, 4A to 4C, 5A to 5C and 6A to 6C.

Important in the embodiment of FIGS. 2A to 2C is the fact that the metal part is pierced in the region of the end opening of the hollow functional elements 10 and that a slug 82 is hereby produced. For this purpose the hollow bore 14 of the functional element 10 of the drawings of FIGS. 2A to 2C is no longer formed as a threaded bore but rather as a cylinder bore which merges in the region of the end face 18 of the functional element 10 into a sharp ring edge 84. In the second phase of the forming process, during the rearward deflection of the plunger, a pressure applied to the sheet metal part is sufficient in order to cut out the slug 90.

The functional element 10 can subsequently be used with a thread forming or thread cutting screw or a thread can be subsequently cut into the bore 14 or the thread cylinder can merge into a stepped bore such as is for example subsequently described in connection with FIGS. 4A to 4C.

It would also be conceivable for the functional element 10 to be provided with only a hollow bore and it could then, for example, be used as a bearing bore for a rotatable shaft or could be designed with a special shape for cooperation with a plug-in pin or the like.

Through the cutting out of the slug 82 it is possible to introduce a bolt element into the functional element and indeed in such a way that its shaft part projects out of the end face 18 of the functional element and through the metal part 12.

In the embodiment of FIGS. 3A to 3C the plunger 60 is equipped with a dome-like preferably hemispherical end face 86 which already forms a corresponding hemispherical recess in the metal part 12 during the first phase of the forming process. After the removal of the finished component assembly (as shown in FIG. 3C) from the tool 24 the hemispherical recess in the metal part 12 serves to receive a tip of a bolt screwed into the functional element 10.

In the embodiment of FIGS. 4A to C the bore 14 of the functional element 10 merges into a stepped bore 90 and the plunger 60 has a tip 92 at the end face 71 of the spigot 70 at the centre and aligned with the longitudinal axis 22. In the first phase of the forming process the metal part 12 is pressed against the tip 96 so that the tip penetrates the metal part and weakens it and indeed so far that the pressure exerted onto the metal part in the region of the end face of the nut element 10 is sufficient to form the sheet material there into an aperture and to subsequently-form the edge region of the aperture into the stepped bore 90, until the metal part finally adopts the position and shape of FIG. 4C. One notes from FIG. 4C that the inner diameter of the shaped sheet metal part in the stepped bore 90 is just sufficiently larger than the base diameter of the thread cylinder 16 so that a bolt introduced into the functional element 10 can project out of the end face 18 of the functional element without contacting the sheet material.

The FIGS. 5A to 5C show a further possibility of piercing a slug 82 from the metal part 12 and indeed using a plunger 60 with an end face 71 with a central recess 94 which is concentric to the longitudinal axis 22. During the first phase of the forming process the sheet material is pressed into the recess 94 and subsequently cut through at the sharp edge in the region of the transition of the stepped bore 14 into the end face 18 of the functional element (where the thread 16 is not present). The already mentioned shape of the slug 82 ensures that it can be pressed through the thread cylinder 16 without the thread cylinder being damaged in an impermissible manner, since the recessed shape of the slug 82 permits, on the one hand, a radially inwardly resilient action of its outer region and in this manner forms an oblique guide surface in the region of a thread cylinder 16 and, on the other hand, significantly reduces the pressure forces prevailing here.

Finally the embodiment of FIGS. 6A to 6C shows an embodiment with a functional element in the form of an bolt element 101 having a head part 102 and a shaft part 104 provided with a thread. In FIGS. 6A to 6C certain features of shape of a bolt element are characterized with the same reference numerals as in the previous Figures in order to make clear the common features with the previously described nut elements, but are however increased by the basic number 100 in order to permit a distinction in the claims. The important distinction between this embodiment and the previously described embodiments lies in the fact that the plunger 60 supports the shaft part 104 at its free end 106 and is thus arranged significantly below the end face 54 of the die 26.

In this embodiment the cylinder portion 138 of the head part 102 of the functional element forms a cylindrical space 108 around the shaft part of the bolt element which serves to receive the axially projecting ring-like projection 52 of the die 26.

The shaft part 104 of the functional element 101 is guided in a centrally arranged longitudinal bore 109 of the die 26.

1. Method for the attachment of a functional element (10; 101) to a deformable metal part (12) using a high pressure forming process in which the metal part (12) is exposed to a fluid pressure at the side remote from the supported functional element (10; 101) and is formed in a forming process starting from one end face (18) of the functional element (10; 101) around at least one portion (28; 102) of the functional element and,; in the region of a radially inwardly extending surface (34; 134) of the functional element which is remote from the end face of the functional element contacting the metal part, into a ring-like radially inwardly directed ring-fold (80), with the functional element (10; 101) being supported during this forming process, characterized in that,
in a second phase of the forming process, the ring-fold (80) is pressed flat between a shaping surface (50) of a die and the radially inwardly extending surface (34; 134) of the functional element (10; 101).

2. Method in accordance with claim 1,
characterized in that
the radially inwardly extending surface (34; 134) of the functional element (10; 101) merges into a cylinder portion (38; 138) directed in the axial direction of the functional element and in that, during the pressing flat of the ring-fold (80) the cylinder portion is formed radially outwardly by the shaping of the die (26) so that at least one part of the ring-fold (80′) lies between the radially inwardly extending surface (34; 134) of the functional element (10; 101) and the cylinder portion (38; 138) which has been changed in shape.

3. Method in accordance with claim 1 or claim 2,
characterized in that
features of shape (46) which form a security against rotation between the functional element (10; 101) and the metal part (12)O are located in the region of the radially inwardly extending surface (34; 134) of the functional element (10; 101) and/or in the region of the cylinder portion (38; 138) and in that, during the shaping of the metal part (12) for the formation of the ring-fold (80), or during the pressing flat of the ring-fold an inter-engagement of the metal part and of the features of shape providing security against rotation is produced.

4. Method in accordance-with claim 1,
characterized in that
the support of the functional element (10; 101) is effected by a plunger (60) provided in the die and in that after the first phase of the shaping process the plunger is permitted to deflect backwardly, whereby the second phase of the shaping process takes place between the die (26) surrounding the plunger and the metal part (12) exposed to fluid pressure.

5. Method in accordance with claim 4,
characterized in that
the plunger (60) is supported by a spring force (62) and in that the backward deflection of the plunger takes place by reduction of the spring force.

6. Method in accordance with claim 4,
characterized in that
the plunger (60) is supported by a spring force and in that the rearward deflection of the plunger is brought about by increasing the fluid pressure acting on the metal part (12).

7. Method in accordance with one of the preceding claims 1 to 4,
characterized in that
the support of the functional element (10; 101) is brought about by the die (26) and in that the second phase of the forming process takes place by increasing the fluid pressure acting on the metal part (12).

8. Method in accordance with one of the preceding claims 1 to 4,
characterized in that
the die (26) with the shaping surface (50) is biased by a force in the direction towards the metal part and in that, for the carrying out of the second phase of the shaping process, the bias force acting on the shaping surface (50) of the die and the fluid pressure acting on the metal part (12) are increased.

9. Method in accordance with one of the preceding claims,
characterized in that
in order to carry out the second phase of the shaping process a tool is used which is pressed onto the metal part (12) contacting the end face of the functional element (10; 101) in order to produce a mechanically increased shaping force.

10. Method in accordance with one of the preceding claims,
characterized in that
the functional element (101) is a bolt element having a head part (102) and a shaft part (104); in that the metal part (12) is formed around the head part of the bolt element in a first phase of the forming process and in that the shaft part (104) of the functional element is movably guided in a bore (109) of the die (26) in the axial direction (22), with the bore being arranged concentric to the forming surface (50) of the die.

11. Method in accordance with claim 11,
characterized in that
the functional element is supported at the free end face (106) of the shaft part (104).

12. Method in accordance with one of the claims 1 to 10,
characterized in that
the functional element (10) is a hollow element having a longitudinal bore (14), such as for example a nut element and in that a support element (60), for example a plunger, is provided which extends from the die side through the hollow element (10) up to its end face (18) contacting the metal part and in that the metal part is supported there at least during the first phase of the forming process.

13. Method in accordance with claim 12,
characterized in that
in the second phase of the forming process, the plunger (60) is retracted, whereby the metal part (12) is pierced in the region of the longitudinal bore (14) to form a removable slug (82) under the action of the fluid pressure acting on the metal part.

14. Method in accordance with claim 13,
characterized in that
the longitudinal bore (14) of the hollow element is formed as a stepped bore (14, 90) having a section (90) of larger diameter adjacent to the end face (18) of the hollow element (10), with the material of the metal part (12) being formed during the forming process into the stepped bore (14; 90) in the region of the larger diameter and forms a collar (97) there having an inner diameter which permits the passage of the shaft part of a bolt which is passed through the longitudinal bore (14, 90).

15. Method in accordance with claim 14,
characterized in that
the free end face (71) of the plunger (60) is executed with a tip (96) in order to weaken the metal of the metal part (12) during the forming process and to enable the forming into the stepped bore (14, 90).

16. Method in accordance with one of the preceding claims,
characterized in that
the end face (71) of the plunger (60) confronting the metal part (12) is provided with a recess (94) in order, on the cutting out of a slug (82), to permit this to be formed into the recess (94) of the plunger (60) by the fluid pressure, whereby a reduction in diameter of the slug (82) takes place and this can be more easily led out of the tool (24).

17. Method in accordance with one of the preceding claims 1 to 12,
characterized in that
the plunger (60) has a convex shape (86) at its free end face (71), for example a hemispherical rounded shape, which projects during the forming process beyond the end face (18) of the functional element (10) and leads to a corresponding shaping (88) of the metal part (12), whereby a receiver (8) for the tip of a bolt element is present.

18. Method in accordance with one of the preceding claims,
characterized in that
the functional element (10; 101) is provided at its end face (18) confronting the metal part (12) with a pronouncedly rounded transition (32) from the end face (18; 118) into its side surface (30; 130) around which the metal part is laid without it being cut through.

19. Method in accordance with one of the preceding claims,
characterized in that
the metal part is a hollow structure which is acted on at the inner side with fluid pressure and is supported at the one outer side in a matching recess of a tool and is supported at the opposite outer side by the die or by a tool surrounding the die.

20. Method in accordance with one of the preceding claims 1 to 18,
characterized in that
the metal part (12) is a sheet metal part which is pressed by a tool (72) onto the side of the sheet metal part remote from the functional element and in that a hollow space (76) is provided in this tool which is exposed to pressure in order to carry out the forming process.

21. Method in accordance with claim 20,
characterized in that
the tool (72) presses the sheet metal part (12) against the end face of the die (26), or against a tool (24) surrounding the die (26), and thus exerts a hold-down function.

22. A component assembly comprising a functional element (10; 101) attached to a deformable metal part (12) in which the metal part (12) contacts one end face (18; 118) of the functional element (10; 101) is guided along a portion of the functional element (30; 102) adjacent to the end face (18) and merges at a radially inwardly extending surface (34; 134) of the functional element, which is remote from the end face (18; 118) of the functional element contacting the metal part (12), into a ring-like radially inwardly directed ring-fold (80′)
characterized in that
the ring-fold (80′) is pressed flat in the region of the radially inwardly extending surface (149; 134) of the functional element (10; 101).

23. Component assembly in accordance with claim 22,
characterized in that
the ring-fold (80′) which is pressed flat is arranged between the radially inwardly extending surface (34; 134) of the functional element (10; 101) and a radially outwardly extending surface of a cylinder portion (38; 138) of the functional element which has been changed in shape.

24. Component assembly in accordance with claim 22 or 23,
characterized in that
features of shape (46; 146) which form a security against rotation between the functional element (10; 101) and the metal part (12) are located in the region of the radially inwardly extending surface (34; 138) of the functional element and/or in the region of the cylinder portion (38; 138), with the features of shape (46; 146) and the metal part (12) inter-engaging in the region of the pressed flat ring-fold (80′).

25. Component assembly in accordance with one of the claims 22 to 24,
characterized in that
the jacket surface (30; 130) of the section (28; 102) of the functional element (10; 101) surrounded by the metal part (12) is equipped with recesses or elevations which are preferably rounded in order to ensure a security against rotation between the functional element and the metal part.

26. Component assembly in accordance with one of the preceding claims 22 to 25,
characterized in that
the functional element is a bolt element (101) having a head part (102) forming the named portion and a shaft part (104).

27. Component assembly in accordance with one of the claims 22 to 25,
characterized in that
the functional element is a hollow element (10), such as for example a nut element.

28. Component assembly in accordance with claim 27,
characterized in that
the metal part (12) has an aperture in the region of the end face (18) of the hollow functional element.

29. Component assembly in accordance with claim 28,
characterized in that
the material of the metal part is formed in the region of the end face (18) of the functional element into a stepped bore (90) of the functional element (10).

30. Component assembly in accordance with one of the preceding claims 22 to 29,
characterized in that
features providing security against rotation are located in the region of the end face of the functional element or in any stepped bore provided there.

31. Component assembly in accordance with one of the preceding claims 22 to 30,
characterized in that
the region of the cylinder portion (38; 138) which has been changed in shape extends, at the side remote from the metal part (12), at least substantially radially to the longitudinal axis (22) of the functional element (10; 101) merges into a corresponding radially extending region of the metal part and lies in a radial plane with the latter.

32. Die (26) for use in a method in one of the claims 1 to 21.
